(19) United States
(12) Patent Application Publication
(10) Pub. No.: US 2014/0331091 A1
(43) Pub. Date: Nov. 6, 2014

(54) Detecting Loss of Data During Data Transfer Between Information Devices

(71) Applicant: International Business Machines Corporation, Armonk, NY (US)

(72) Inventor: Yoshikuni Murakami, Tokyo (JP)

(21) Appl. No.: 14/361,982

(22) PCT Filed: Oct. 3, 2012
(86) PCT No.: PCT/JP2012/075620

§ 371 Date: May 30, 2014

(30) Foreign Application Priority Data
Dec. 8, 2011 (JP) 2011-268718

(51) Int. Cl. G06F 11/14

(52) U.S. Cl. CPC G06F 11/1412
USPC 714/37

(57) ABSTRACT

A mechanism is provided for detecting data loss in transfer data between a first information device and a second information device. The second information device receives transfer data sent by an application of the first information device, the transfer data being segmented into pieces and, for each segmented data piece, there is a write hash value, k hash value is generated for the segmented data piece that has been received, and the generated hash value is stored in the dedicated buffer in the second information device as a read hash value. The write hash value and the read hash value are compared and, when the write hash value associated with the segmented data piece and the read hash value of the segmented data piece do not match, it is determined that data has been lost from the transfer data at a time of transfer of the segmented data piece.

### BACKGROUND

The present invention relates to detection of loss of data during data transfer between information devices connected to each other over an external network. More specifically, the present invention relates to a method of detecting toss of data during data transfer between a server and an external storage system connected to each other over an external network.

FIG. 1 illustrates a state where a plurality of servers are connected to a plurality of external storages over an external network. Servers transfer data to storage devices (storage systems, storages) and store the data in the storage devices. A storage application that runs on a server passes data to an HBA (Host Bus Adapter) device driver via a file system of the OS. An HBA sends the data to a data transfer path called a fiber (fibre) channel. The data reaches an external storage via a SAN (Storage Area Network) that exists in the middle of the fiber channel and is stored in the external storage.

An external network includes various components that are included in data transfer paths of the external network. When transferring data over an external network, a server may fail to make the whole data reach a storage as expected and part of the data may be lost. Loss of data is a critical issue in data integrity.

In terms of techniques, a check sum or a CRC (Cyclic Redundancy Check) is performed in data transfer sections connecting information devices, such as servers. However, such check functions are not effective in the case where a function that handles passing of data in data transfer between information devices, such as servers, fails. The check functions are not techniques that aim to obtain data continuity (detecting loss of data) at an OS level.

In Japanese Unexamined Patent Application Publication No. 2002-268542, after data stored in a file system has been transferred, the data is checked using a hash value and, if an error is detected, the whole data will be resent.

In Japanese Unexamined Patent Application Publication No. 2004-185188, in order to transfer data between servers with certainty, data is transferred while being segmented into pieces and a hash value is generated for each piece, while loss of data is checked by using consecutive numbers.

### SUMMARY

In one illustrative embodiment, a method is provided for detecting data loss in transfer data between a first information device and a second information device. The illustrative embodiment receives, by a second processor in the second information device, the transfer data sent by an application of the first information device, wherein the transfer data is segmented into pieces in a temporal transfer direction and wherein for each segmented data piece in the segmented pieces of data there is a write hash value, storing the received transfer data in a second buffer of the second information device, receiving the write hash value, and storing each write hash value for each segmented data piece in a dedicated buffer in the second information device by associating the write hash value with the segmented data piece included in the transfer data. The illustrative embodiment reads, by the second processor in the second information device, the segmented data piece stored in the second buffer, generating a hash value for the segmented data piece, and storing the generated hash value in the dedicated buffer in the second information device as a read hash value. The illustrative embodiment compares, by the second processor in the second information device, the write hash value and the read hash value stored in the dedicated buffer. The illustrative embodiment determines, by the second processor in the second information device, that data has been lost from the transfer data at a time of transfer of the segmented data piece in a case where the write hash value associated with the segmented data piece and the read hash value of the segmented data piece do not match in the comparison.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment,

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of the following detailed description of the example embodiments of the present invention.

### BRIEF DESCRIPTION OF THE SEVERAL VIEWS OF THE DRAWINGS

FIG. 1 illustrates a state where a plurality of servers are connected to a plurality of external storages over an external network.

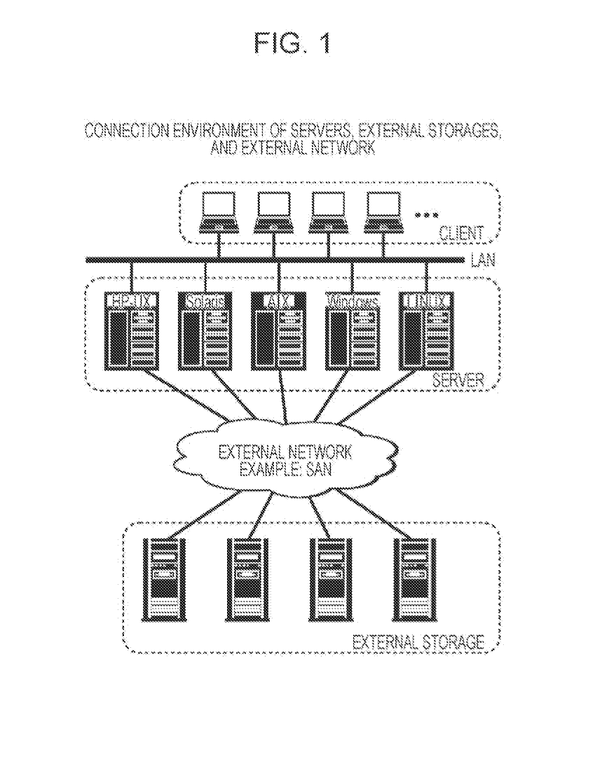

FIG. 2 illustrates devices that constitute a network storage, their H/W and SW configurations, and a scope covered by the present invention, in which loss of data may occur.

FIG. 3 is a schematic diagram illustrating a method of using hash values according to the present invention.

FIG. 4 is a flow illustrating data loss detection for segmented data pieces according to the present invention.

FIG. 5 illustrates three cases in which exchange and comparison are performed for a hash check.

FIG. 6 is a schematic diagram illustrating a method of using a plurality of types of hash values according to the present invention.

### DETAILED DESCRIPTION

Embodiments (exemplary embodiments) will be described below which involve a case where data is transferred from a server to an external storage and is written into the external storage. Note that the present invention is generally applicable to a case of verifying data integrity end to end between information devices connected to each other over an external network.

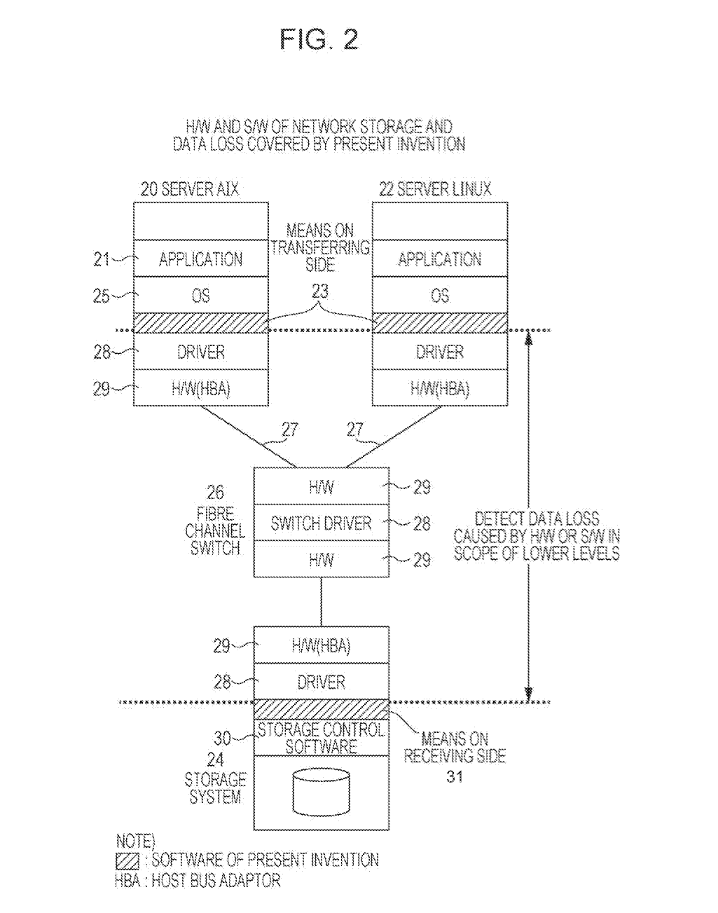

FIG. 2 illustrates devices that constitute a network storage, their H/W and S/W configurations, and a scope covered by the present invention, in which loss of data may occur. In data transfer at a higher level, such as an application level or an OS level, a hash value is calculated on a server side and on a storage side for transfer data of a fixed size or for data transferred in a fixed period of time. The two hash values are compared, a failure in data transfer at a lower level is detected in real time, and data integrity is verified. Here, as illustrated in FIG. 2, OSs 25, applications 21, and storage control software 30 in end-to-end devices 20, 22, and 24, which execute instructions to write/read data to/from an external network, are referred to as higher levels. Lower levels are levels below such higher levels and include H/Ws 27 and 29 and S/W resources 28 that are engaged in data transfer.

In data transfer at a lower level, an appropriate completion notification is not necessarily delivered to a higher level due to a defect in the data processing logic of a tower level, For example, in the case where data having a large size is to be transferred, the data is segmented into smaller pieces and transferred. Even if error processing is performed in response to the occurrence of some failure during segmentation and transfer, the error processing performed at a lower level may not be appropriate for a higher level. Even if a higher level determines that transfer has been successfully completed, a situation could arise where data in the middle of the data stream has not been transferred actually. In this case, in terms of data continuity at a higher level, occurrence of loss of data due to data in the middle of the data stream not having been transferred can be avoided by retrying a command.

By integrating means 23 and 31 that verify data continuity at a higher level, loss of data that is not detectable with the H/W (hardware) and S/W (software) configurations in the scope of the lower levels can be detected. The server 20 employs AIX as the OS 25 and runs the storage application 21. The server 22 employs LINUX as the OS 25 and runs the storage application 21. The servers 20 and 22 are each connected to a Fibre Channel switch 26 via a network card 29 (for example, HBA: Host Bus Adapter 29), its driver 28, and a communication line 27. The storage system 24 reads/writes data from/to a recording medium by using the storage control software 30. The storage system 24 is connected to the Fibre Channel switch 26 via the communication line 27 by using the HBA 29 and its driver 28, for example. The Fibre Channel switch 26 constitutes an external network, that is, a SAN (Storage Area Network).

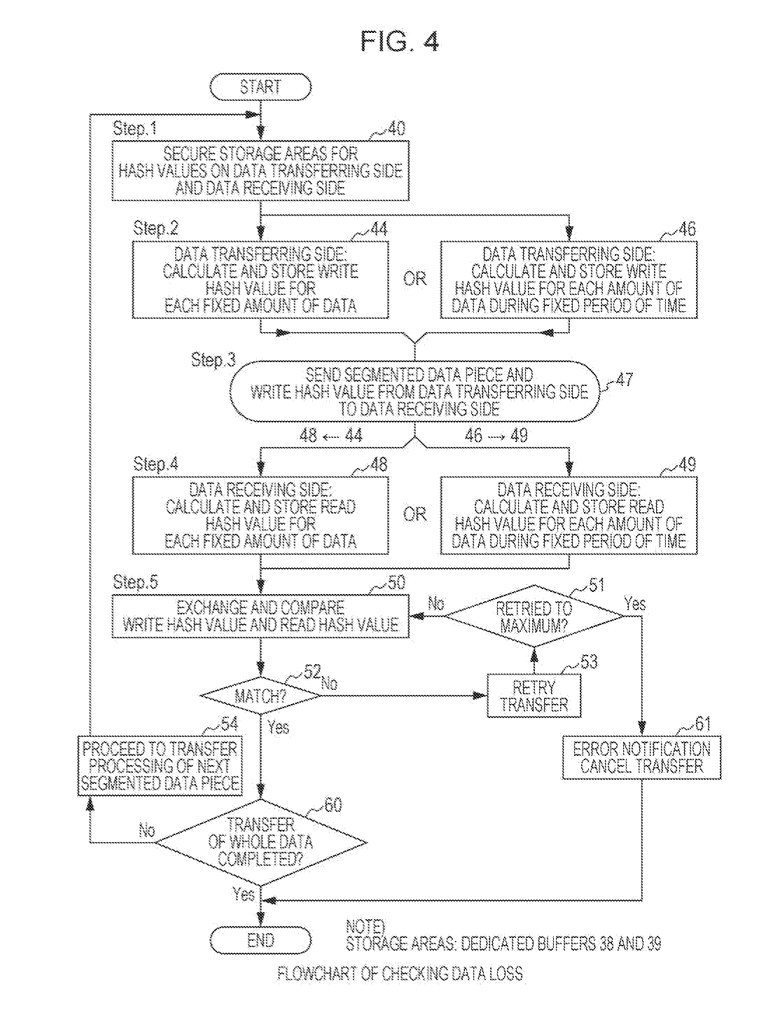

The means 23 of the servers 20 and 22 (transferring side) and the means 31 of the storage system 24 (receiving side) are interposed between the higher levels and the lower levels and implement a function of the present invention. The details of the function of the present invention will be illustrated in a processing flow in FIG. 4. The means 23 of the present invention performs data buffering, hash values, comparison of hash values, and the like in conjunction with data transfer processing performed for writing by the application 21. A copy command and a compare command that implement the function of the present invention need to be executed. Such command functions may be incorporated into a library function of the OS 25 or may be incorporated into a library of the storage application 21.

Two examples of a cause of toss of data that occurs end to end at a lower level will be described.

As a first example, a case wilt be described where a fiber cable is disconnected and loss of part of data occurs but the data is written into a storage. One path of an FC cable is disconnected during data transfer and loss of data in the middle of the data stream occurs. When a portion in the storage corresponding to a write address is read, data that was previously written is read. Even if one path of an FC cable is disconnected, data should be transferred as long as the other path is active. The loss of data is due to a problem in an FC protocol in a driver. In the next example, loss of data occurs even in the case where data transfer is performed between storages. In the case of copying between storages that are connected to an external network, loss of data occurs in a write destination storage. Firmware on the storage side which manages network access has a bug. The loss of data occurs because of a wrong transfer destination address, caused by the bug, which is used when data is transferred from a transfer source to a transfer destination. Transfer of data to a wrong address is considered to be loss of data occurring during data transfer.

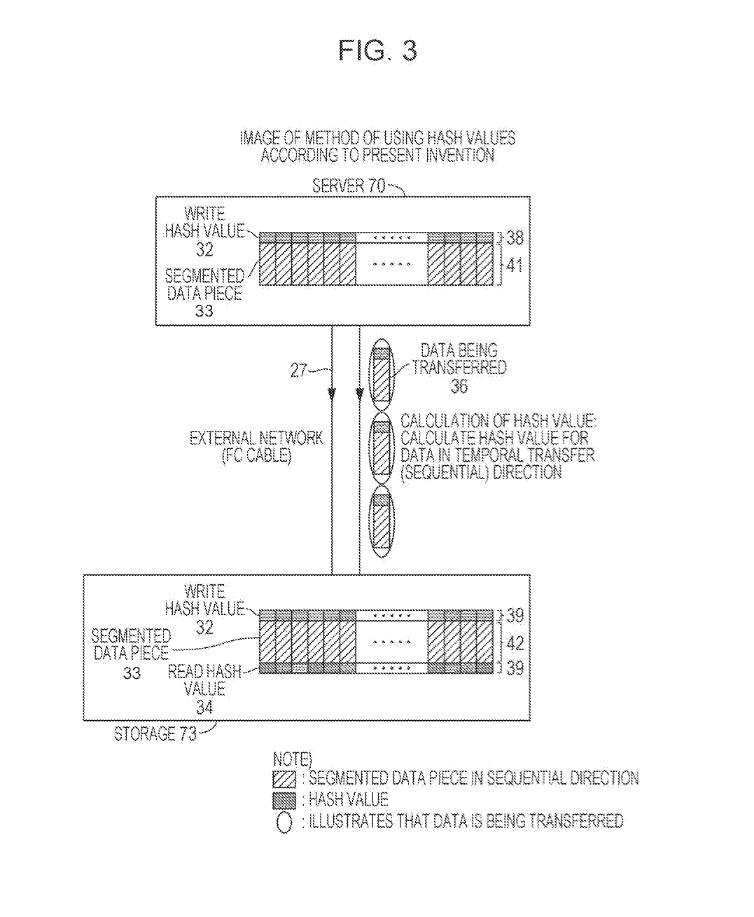

FIG. 3 illustrates an image in which a hash value is calculated for a segmented data piece 33, is associated with the segmented data piece 33 as a write hash value 32, and is stored in a dedicated buffer 38. It is assumed that the application 21 that runs in a server 70 is recorded in a recording medium and executes an instruction to write large-volume data in a storage 73. The application 21 temporarily stores transfer data in a memory area (buffer) 41. The means 23 of the present invention temporarily stores transfer data in a dedicated buffer 38 via an application library or the OS 25.

The dedicated buffer 38 is for the means 23 of the present invention. The application 21 does not need to manage and use the dedicated buffer 38 and therefore the dedicated buffer 38 is distinguished from the buffer 41. The buffer 41 for the application 21 and the dedicated buffer 38 for software of the present invention may use a physically continuous DRAM by partitioning the DRAM. To the storage 73, buffer management is similarly applied as in the foregoing case of the server 70. The dedicated buffer 39 is for the means 31 of the present invention. The storage control software 30 of the storage 73 does not need to manage and use the dedicated buffer 39 and therefore the dedicated buffer 39 is distinguished from a buffer 42.

The means 23 of the present invention manages data that is temporarily stored in the buffer 41 and is to be transferred, for each piece of data (segmented data piece 33) obtained by segmenting the data, the piece of data being a unit for which a hash value is calculated. Note that the segmented data piece 33 is not a unit of data for transfer. The unit of transfer is determined on the basis of a communication protocol. The present invention is not intended to change the unit of transfer. The means 23 of the present invention specifies the segmented data piece 33 from the data stored in the buffer 41 of the application 21, for which a hash value is calculated, separately from data transfer processing. The means 23 of the present invention generates the write hash value 32 from the segmented data piece 33 and temporarily stores the generated value in the dedicated buffer 38.

The write hash value 32 and the segmented data piece 33 may be separated from each other and stored as long as they are associated with each other. The write hash value 32 is associated with the segmented data piece 33 and is sent separately from the segmented data piece 33. Association of each hash value with a corresponding segmented data piece needs to be made. A segmented data piece for which a hash value is generated is part of transfer data stored in the buffer 41 of the application 21. To each hash value, attribute information for association is given in addition to a value of the hash value itself. For example, the attribute information includes a linked list for linking each segmented data piece in transfer data stored in the buffer 41 with a hash value for indexing. The indices for indexing include a start address (offset) position from the head address of the buffer 41, the fixed number of bytes, and the like, The write hash value 32 is stored in the buffer 38 by giving, to the write hash value, the attribute information including the linked list in which these indices are contained.

Note that, in FIG. 3, in data 36 that is being transferred via the communication line 27, the segmented data piece 33 and the write hash value 32 are joined together. In an actual transfer sequence, the application 21 does not recognize the existence of the hash value. Therefore, the hash value 32 handled by the means 23 of the present invention and transfer data sent by the application 21 are separated from each other and sent.

The storage 73 receives the segmented data piece 33 that has been transferred and stores it in the buffer 42. The transferred write hash value 32 is similarly stored in the buffer 39 by being paired with the corresponding segmented data piece 33, which is schematically illustrated. The write hash value 32 and the segmented data piece 33 may be stored separately from each other as long as they are associated with each other. The storage 73 calculates a read hash value 34 from the segmented data piece 33 stored in the buffer 42 and stores the calculated value in the buffer 39. In the buffer 39 of the storage 73, the write hash value 32 and the read hash value 34 exist. The means 31 of the present invention compares the write hash value 32 with the read hash value 34 in Step 5 in a flow of FIG. 4 described below.

FIG. 4 illustrates a flow of verification of data integrity on the basis of segmented data pieces according to the present invention. The flow of the present invention of generating (calculating), exchanging, and comparing a write hash value and a read hash value will be described with reference to the figure.

Step 1 (40): The storage areas (dedicated buffers) 38 and 39 for hash values are secured on a data. transferring side and a data receiving side respectively.

For example, in FIG. 3, the data transferring side is the server 70 and the data receiving side is the storage 73. As saving areas of calculated hash values, unused areas in the storage areas (memory areas, buffers) 41 and 42 for transfer data may be used as temporary work areas.

Step 2 (44 or 46): On the data transferring side, a write hash value is calculated and stored for each fixed amount of data or for each amount of data during a fixed period of time. On the data transferring side, a write hash value is calculated for each fixed amount of data (44). Alternatively, a write hash value is calculated for each amount of data that has been transferred during a period of time that has been set in advance (46). If the data transfer rate is not constant, in the case of calculation for each fixed amount of data (44), it takes time to check segmented data pieces being transferred during a period in which the rate is decreased, and data continuity cannot be verified in real time.

Step 3 (47): The write hash value is sent from the data transferring side to the data receiving side by associating the write hash value with a corresponding segmented data piece.

Step 4 (48 or 49): A read hash value is calculated and stored on the data receiving side for each fixed amount of data or for each amount of data transferred during a fixed period of time. On the data receiving side, a read hash value is calculated for each fixed amount of data (48). Alternatively, a read hash value is calculated at an interval that has been set in advance (49).

On the receiving side, a read hash value is generated by using a hash calculation that has been used on the transferring side for the same segmented data piece. If the data transfer rate is not constant, in the case of calculation for each fixed amount of data (48), it takes time to check segmented data pieces being transferred during a period in which the rate is decreased, and data continuity cannot be verified in real time.

Step 5 (50): The write hash value and the read hash value are exchanged and compared.

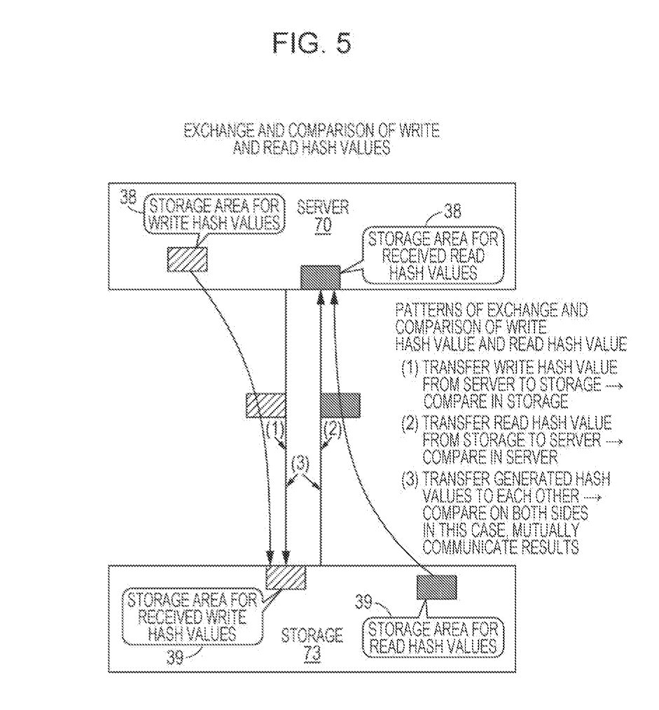

Exchange of hash values between the transferring side and the receiving side can be performed by using read/write commands on a logical block address (LBA) that is not used, for example. It is also possible to exchange hash values by expanding an SCSI command. Received hash values are stored in buffers on the transferring side and the receiving side respectively. The write hash value and the read hash value are compared. For comparison of hash values, there are three methods as illustrated in FIG. 5, and the comparison is performed in the server, in the storage, or in both of them. If the hash values match as a result of comparison (Yes in 52), the processing proceeds. If transfer of the whole data has been completed (Yes in 60), data continuity is verified and it is determined that there is no toss of data. If the hash values do not mach as a result of comparison (No in 52), transfer is retried. Transfer (Steps 1 to 5) of the same segmented data piece is retried (53). An error is logged (recorded). Logging of an error is performed in three ways as illustrated in FIG. 5, that is, in the server, in the storage, or in both of them, in the case where comparison of hash values is performed. For the same segmented data piece, a retry is made for the number of retries (maximum value) that has been set in advance (51). If a retry is successful (Yes in 52) and if the whole data transfer has not been completed (No in 60), the procedure goes to next data transfer (54). If a retry fails when the number of retries reaches the maximum value (Yes in 51), an error notification is sent to the server and the subsequent transfer is canceled (61)).

FIG. 5 illustrates three cases of exchange and comparison for a hash check. It is possible to implement comparison of hash values in Step 5 in the following ways, that is, comparison is performed (1) on the receiving side (storage 73), (2) on the transferring side (server 70), or (3) on both sides. These cases differ in terms of reliability and the reliability level is highest in (3), then (2), and then (1). On the other hand, the performance level is highest in (1), then (2), and then (3). The case (3) where comparison and checking of hash values are performed on both sides is most reliable, however, it has a drawback in terms of performance.
(1) A case Where comparison is performed in the storage 73: in this case, a write hash value is transferred from the server 70 to the storage 73 and comparison is performed in the storage 73. A write hash value is written into the storage area (dedicated buffer) 38 determined by the server 70 in Step 1. At the point of completion of a write command, the storage 73 reads the write hash value from the buffer 38. The write hash value that has been read and a read hash value that has been stored in the storage 73 are compared. In this case, an SCSI command results in abnormal termination and a retry is made in the server 70.
(2) A case where comparison is performed in the server 70: In this case, a read hash value is transferred from the storage 73 to the server 70 and comparison is performed in the server 70. The storage 73 writes a read hash value into the storage area (dedicated buffer) 39 determined in Step 1. At the point of completion of a write command, the server 70 reads the read hash value from the dedicated buffer 39. The read hash value that has been thus received and a write hash value that has been stored in the buffer 38 in the server 70 are compared. In this case, an error is detected only in the server 70 and an SCSI command results in successful completion.
(3) A case where comparison is performed on both sides: In this case, hash values respectively generated by the server 70 and the storage 73 are transferred to each other and comparison is performed on both sides. Here, results obtained by the hash values being compared, are mutually communicated. The two areas, that is, the storage area (dedicated buffer) 38 in the server 70 which stores write hash values and the storage area (dedicated buffer) 39 in the storage 73 which stores read hash values are determined in advance. At the point of completion of write commands, the devices (information devices) each compare the hash values.

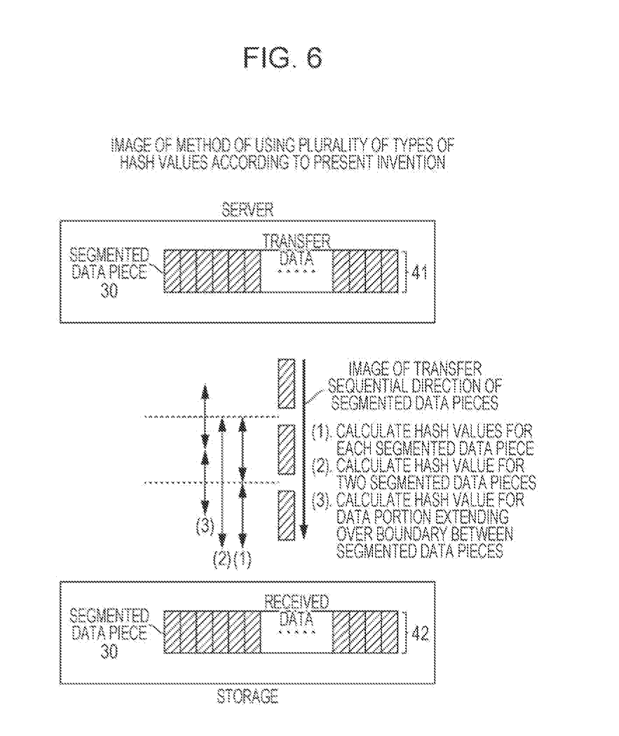

FIG. 6 is a schematic diagram illustrating a method of using a plurality of types of hash values according to the present invention. The present invention includes use of a plurality of hash functions for a single segmented data piece 30. It is necessary to avoid a situation where, even if a segmented data piece 30 is lost, a failure in continuity cannot be detected because of a write hash value being equal to a read hash value (collision). Omission of detection of data loss can be minimized by comparing a plurality of types of hash values for the same data.

An exemplary embodiment involves a case where a unit (segmented data piece 30) for which a hash value is calculated, in the case of large-volume data, is a fixed amount of data, and a hash value is calculated for this unit. The size of the fixed length for verification is configurable by taking into consideration the transfer rate. In the case of 4 Gbps, if calculation of a hash value is set to be performed for each segmented data piece 30 of 200 MB, checking will be performed every 0.5 seconds. The hash value is small in terms of data size and therefore transfer and comparison are completed immediately. On the other hand, in the case where data is read from a point located the number of transfer bytes back and comparison is performed for confirmation of writing, overhead time for reading and comparison is required. If the transfer rate of a fiber channel is 4 Gbps, this means 400 MBS. For example, transfer of 4 GB data takes 10 seconds. Since reading takes 10 seconds, if it is assumed that comparison time is 5 seconds, confirmation of transfer will take 10+10+5 seconds, that is, 25 seconds. In the case of a hash check of the present invention, if it is assumed that hash data is 1 KB in size, transfer time is approximately 2.5×10-6. If 4 GB data is transferred and the fixed length for hash calculation is 400 MB, a hash value will be transferred four times. In this case, the total transfer time is approximately 10-5. The total time of writing and transfer time and transfer time of hash values is considered to be substantially equal to the writing and transfer time. Data continuity can be verified in half or less the time required in the case of comparison after reading data from a point located back. For example, in order to verify data continuity, usually a copy command and a compare command need to be executed. If the present invention is applied to a library function of the OS, continuity can also be verified simultaneously with substantially no overhead time only by executing a copy command. In the case of moving a file or a folder in Windows, comparison of a moving source file and a moving destination file cannot be performed. If the present invention is applied, data continuity after moving is also ensured only by a moving operation.

A case is illustrated in (1) of FIG. 6 where, in calculation of hash values, a plurality of hash functions are used for a single segmented data piece 30. In the case of using hash values, hash collision may occur. Therefore, different hash values are used and calculation results from the different hash values are compared, If matching is confirmed in all of the results, it is determined that normality is verified. In this way, collision of hash values is avoided. If higher reliability is desired, a plurality of algorithms are simultaneously calculated and comparison is performed. For example, it is possible to combine SHA1 and SHA512 below. If a plurality of hash functions (bash algorithms are used together, the possibility of false recognition due to collision of hash values can be reduced.

Table of Hash Algorithms

| Algorithm | Hash length |
|---|---|
| SHA1 | 160 bits |
| SHA256 | 256 bits = 32 bytes |
| SHA512 | 512 bits = 64 bytes |

(2) of FIG. 6 illustrates a case where a hash value is calculated for every two segmented data pieces 30 as well as for each segmented data piece 30. In calculation of hash values, by supplementarily calculating a hash value for each segmented data piece 30 of a different fixed length, it will be possible to detect loss of data with more certainty. A hash value is generated for each segmented data piece 30. A hash value is calculated for two or more consecutive segmented data pieces 30 including the segmented data. piece 30. In the case where loss of data occurs in units of segmented data pieces 30 for transfer, loss of data can be detected with certainty only by comparison using one hash value, For one segmented data piece 30, the time for generation and transfer of two hash values and comparison is actually Required. The time required for generation and transfer of one hash value and comparison is sufficiently short (less than 1%) compared with the time required for transfer and comparison of a. segmented data piece 30 itself, Generation and the like of two hash values has little impact on real-time detection of loss of data. By examination using a plurality of hash values, the data toss detection rate, which is not satisfactory with one hash value, can be improved.

(3) of FIG. 6 illustrates a case where a hash value is calculated for a data portion that extends over the boundary between two segmented data pieces 30. In the case of fixed length-based calculation, anon-overlapped portion is present in each segmented data piece 30 of a fixed length for which a hash is calculated. In order to eliminate such a non-overlapped portion, a hash value is calculated at a position obtained by somewhat shifting the position of data from which examination is started. Accordingly, it becomes possible to continue calculating hash values seamlessly in data transfer in case loss of a data portion that extends over segmented data pieces 30 occurs. With this data loss detection method, the possibility of detecting consecutively occurring data loss is increased and higher reliability can be attained in end-to-end data integrity.

Another exemplary embodiment involves a case where a unit (segmented data piece 30) for which a hash value is calculated, in the case of large-volume data, is an amount of data that is transferred during each fixed period of time, and a hash value is calculated for this unit. Data that has been accumulated and stored in the buffer 41 of the application during a fixed period of time is regarded as a segmented data piece 30 and a hash value is calculated for this unit. Generally, a pair of information devices is not allowed to occupy a certain bandwidth for transfer in the case of transfer for backup or asynchronous transfer between storages. For example, in remote backup of large-volume data or in asynchronous transfer between storages, only a communication line having a low transfer capacity may be available because of costs. In the case where a communication line is shared, the transfer rate changes temporally because a bandwidth is not guaranteed. In a certain time zone, a bandwidth that is available may become very small. For example, it is assumed that transfer of 10 TB data takes 10 days with a communication line having a low transfer capacity. As described above, in the case where a hash value is calculated for every 1 TB, data consistency is checked only once a day and therefore data inconsistency cannot be detected in real time. In such a case, if data is segmented every 10 seconds or every minute, regardless of whether or not the size of transfer data reaches a specified value, and a hash value is calculated, sent, and checked, it becomes possible to verify data consistency in real time. In the foregoing example, a hash is calculated for each data portion of approximately 700 MB in the case of segmentation being performed every minute. Consistency detection on a minute-by-minute basis and consistency detection on a day-by-day basis results in retransmission efficiency differing by approximately 1400 times, In the case where an amount of transfer data is small, the possibility of collision of hash values becomes low. Therefore, acceleration of hash calculation becomes possible by dynamically selecting a hash function from a table of hash algorithms which corresponds to an amount of transfer data that has been set in advance.

An amount of data transferred during each fixed period of time is a unit (segmented data piece 30) for which a hash value is calculated and is not a unit of an amount of data to be transferred to the buffer 42 the receiving side (storage). Data accumulated in the buffer 41 .in the server is segmented at a fixed time interval, the obtained pieces are regarded as segmented data pieces 30, and hash values are calculated respectively. A segmented data piece 30 is a unit for which a hash value is calculated and does not necessarily mean a unit of an amount of data transferred between the server and the storage.

As described above, the software means of the present invention supports end-to-end terminals connected over an external network and is installed in a server and a storage. The software means of the present invention is implemented by modification of an application, expansion of a library call, or expansion of a function call. Expansion of a library call or a function call does not have an impact on an existing application.

If the foregoing means is implemented, loss of data during end-to-end data transfer between information devices connected to each other over an external network that includes various components can be detected in real time. Such detection of loss of data has an advantageous effect in that data restoration processing can be performed in real time. With the present invention, garbled data in transfer data can also be detected, which further ensures data integrity.

The present invention has been described above with reference to the embodiments, however, the scope of the present invention is not limited to the foregoing exemplary embodiments. The present invention is applicable to data transfer from a server to a server, from a storage to a storage, or from a storage to a server. The application is not limited to a storage application. Examples of the application widely include various tools, such as utilities. It is obvious to a person skilled in the art that various modifications can be made or alternative forms can be taken without departing from the spirit and scope of the present invention.

1. A method of detecting data loss in transfer data between a first information device and a second information device, the method comprising:
receiving, by a second processor in the second information device, the transfer data sent by an application of the first information device wherein the transfer data is segmented into pieces in a temporal transfer direction and wherein for each segmented data piece in the segmented pieces of data there is a write hash value, storing the received transfer data in a second buffer of the second information device, receiving the write hash value, and storing each write hash value for each segmented data piece in a dedicated buffer in the second information device by associating the write hash value with the segmented data piece included in the transfer data;
reading, by the second processor in the second information device, the segmented data piece stored in the second buffer, generating a hash value for the segmented data piece, and storing the generated hash value in the dedicated buffer in the second information device as a read hash value;
comparing, by the second processor in the second information device, the write hash value and the read hash value stored in the dedicated buffer; and
determining, by the second processor in the second information device, that data has been lost from the transfer data at a time of transfer of the segmented data piece in a case where the write hash values-value associated with the segmented data piece and the read hash value of the segmented data piece do not match in the comparison.

2-5. (canceled)

6. The method of claim 1, wherein each segmented data piece is of a fixed amount of data in the transfer data, and each write hash value is calculated for each segmented data piece of the fixed amount.

7. The method of claim 1, wherein each segmented data piece is of a variable amount of data accumulated in the first buffer by the application during a fixed period of time, and each write hash value is calculated for each segmented data piece of the variable amount.

8. The method of claim 1, further comprising:
responsive to detecting that data has been lost from the transfer data at a time of transfer of the segmented data piece, performing, by the second processor in the second information device, restoration processing to recover the data.

9-12. (canceled)

13. The method of claim 1, wherein the first information device comprises the application that transfers data via a first buffer and wherein the second information device being connected to the first information device over an external network so as to be able to communicate with the first information device.

14. The method of claim 13, further comprising:
segmenting, by a first processor in the first information device, the transfer data accumulated in the first buffer for the application into segmented pieces of data in a temporal transfer direction;
reading, by the first processor in the first information device, each segmented data piece of the segmented pieces of data;
generating, by the first processor in the first information device, a hash value for the segmented data piece; and
storing, by the first processor in the first information device, the generated hash value in a dedicated buffer in the first information device as a write hash value.

15. The method of claim 14, further comprising:
sending, by the first processor in the first information device, the write hash value from the first information device to the second information device by associating the write hash value with the segmented data piece included in the transfer data stored in the first buffer.

16. A computer program product comprising a computer readable storage medium having a computer readable program stored therein, wherein the computer readable program, when executed on a computing device, causes the computing device to:
receive, in a second information device, transfer data sent by an application of a first information device, wherein the transfer data is segmented into pieces in a temporal transfer direction and wherein for each segmented data piece in the segmented pieces of data there is a write hash value, storing the received transfer data in a second buffer of the second information device, receiving the write hash value, and storing each write hash value for each segmented data piece in a dedicated buffer in the second information device by associating the write hash value with the segmented data piece included in the transfer data;
read, in the second information device, the segmented data piece stored in the second buffer, generating a hash value for the segmented data piece, and storing the generated hash value in the dedicated buffer in the second information device as a read hash value;
compare, in the second information device, the write hash value and the read. value stored in the dedicated buffer; and
determine, in the second information device, that data has been lost from the transfer data at a time of transfer of the segmented data piece in a case where the write hash value associated with the segmented data piece and the read hash value of the segmented data piece do not match in the comparison.

17. The computer program product of claim 16, wherein each segmented data piece is of a fixed amount of data in the transfer data, and each write hash value is calculated for each segmented data piece of the fixed amount.

18. The computer program product of claim 16, wherein each segmented data piece is of a variable amount of data accumulated in the first buffer by the application during a fixed period of time, and each write hash value is calculated for each segmented data piece of the variable amount.

19. The computer program product of claim 16, wherein he computer readable program further causes the computing device to:
responsive to detecting that data has been lost from the transfer data at a time of transfer of the segmented data piece, perform, in the second information device, restoration processing to recover the data.

20. The computer program product of claim 16, wherein the first information device comprises the application that transfers data via a first buffer and wherein the second information device being connected to the first information device over an external network so as to be able to communicate with the first information device.

21. The computer program product of claim 20, wherein the computer readable program further causes the computing device to:
segment, in the first information device, the transfer data accumulated in the first buffer for the application into segmented pieces of data in a temporal transfer direction;
read, in the first information device, each segmented data piece of the segmented pieces of data;
generate, in the first information device, a hash value for the segmented data piece; and
store, in the first information device, the generated hash value in a dedicated buffer in the first information device as a write hash value.

22. The computer program product of claim 21, wherein the computer readable program further causes the computing device to:
send, in the first information device, the write hash value from the first information device to the second information device by associating the write hash value with the segmented data piece included in the transfer data stored in the first buffer.

23. An apparatus comprising:
a second processor in a second information device; and
a second memory coupled to the second processor, wherein the second memory comprises instructions which, when executed by the second processor, cause the second processor to:
receive, in a second information device, transfer data sent by an application of a first information device, wherein the transfer data is segmented into pieces in a temporal transfer direction and wherein for each segmented data piece in the segmented pieces of data there is a write hash value, storing the received transfer data in a second buffer of the second information device, receiving the write hash value, and storing each write hash value for each segmented data piece in a dedicated buffer in the second information device by associating the write hash value with the segmented data piece included in the transfer data;
read, in the second information device, the segmented data piece stored in the second buffer, generating a hash value for the segmented data piece, and storing the generated hash value in the dedicated buffer in the second information device as a read hash value;
compare, in the second information device, the write hash value and the read hash value stored in the dedicated buffer; and
determine, in the second information device, that data has been lost from the transfer data at a time of transfer of the segmented data piece in a case where the write hash value associated with the segmented data piece and the read hash value of the segmented data piece do not match in the comparison.

24. The apparatus of claim 23, wherein each segmented data piece is of a fixed amount of data in the transfer data, and each write hash value is calculated for each segmented data piece of the fixed amount.

25. The apparatus of claim 23, wherein each segmented data piece is of a variable amount of data accumulated in the first buffer by the application during a fixed period of time, and each write hash value is calculated for each segmented data piece of the variable amount.

26. The apparatus of claim 23, wherein the instructions further cause the processor to:
responsive to detecting that data has been lost from the transfer data at a time of transfer of the segmented data piece, perform, in the second information device, restoration processing to recover the data.

27. The apparatus of claim 23, wherein the first information device comprises the application that transfers data via a first buffer and wherein the second information device being connected to the first information device over an external network so as to be able to communicate with the first information device.

28. The apparatus of claim 27, further comprising
a first processor in a first information device; and
a first memory coupled to the first processor, wherein the first memory comprises instructions which, when executed by the first processor, cause the first processor to:
segment, in the first information device, the transfer data accumulated in the first buffer for the application into segmented pieces of data in a temporal transfer direction;
read, in the first information device, each segmented data piece of the segmented pieces of data;
generate, in the first information device, a hash value for the segmented data piece; and
store, in the first information device, the generated hash value in a dedicated buffer in the first information device as a write hash value.
